(19) United States
(12) Patent Application Publication
(10) Pub. No.: US 2020/0088127 A1
(43) Pub. Date: Mar. 19, 2020

(54) PISTON HAVING AN UNDERCROWN SURFACE WITH COATING AND METHOD OF MANUFACTURE THEREOF

(71) Applicant: Federal-Mogul LLC, Southfield, MI (US)

(72) Inventors: Timothy C. Vezina, Northville, MI (US); Warran Boyd Lineton, Chelsea, MI (US); Jeffrey Lee Riffe, Troy, MI (US)

(21) Appl. No.: 16/133,053

(22) Filed: Sep. 17, 2018

(51) Int. Cl. F02F 3/00; F02B 51/02; F02F 3/26; F02F 3/20

(52) U.S. Cl. CPC F02F 3/0069; F02F 3/0092; B01J 23/464; F02F 3/26; F02F 3/20; F02B 51/02

(57) ABSTRACT

A vehicle internal combustion piston and method of construction thereof are provided. The piston includes piston body extending along a central longitudinal axis, having an upper combustion wall forming an upper combustion surface and an undercrown surface opposite the upper combustion surface. An annular ring belt region depends from the upper combustion surface, a pair of skirt panels depend from the ring belt region, and a pair of pin bosses depend from the undercrown surface to provide laterally spaced pin bores aligned along a pin bore axis for receipt of a wrist pin. The undercrown surface forms a central undercrown region, and a portion of either an open outer cooling gallery, a sealed outer cooling gallery, or an outer galleryless region. A coating comprising a base layer including nickel and a catalyst layer including rhodium is applied to the undercrown surface.

### BACKGROUND OF THE INVENTION

### 1. Field of the Invention

This invention relates generally to pistons for internal combustion engines, and methods for manufacturing the pistons.

### 2. Related Art

Pistons used in internal combustion engines, such as heavy duty diesel pistons, are exposed to extremely high temperatures during operation, especially along the crown of the piston. Engine and piston manufacturers typically attempt to control the temperature of the crown and reduce heat loss from the combustion chamber to the crown, in order to maintain usable fuel energy and high gas temperature inside the combustion chamber, and to achieve a higher engine brake thermal efficiency (BTE).

To moderate the temperature of the crown, some pistons are designed with a cooling gallery beneath the crown, wherein cooling oil is sprayed into the cooling gallery and onto an undercrown surface as the piston reciprocates along a cylinder bore of the engine. The oil flows along the inner surface of the cooling gallery and dissipates heat from the crown. However, to control the piston temperature during operation, a high flow of oil must be constantly maintained, which adds to the parasitic losses, which in turn reduces the engine fuel efficiency. In addition, the oil degrades over time due to the high temperature of the internal combustion engine, and thus, the oil must be changed periodically to maintain adequate engine life.

Another way to control the temperature of the crown is to design the piston with a sealed cooling gallery containing coolant media which are more heat resistant than oil when exposed to high temperatures. U.S. Pat. No. 9,127,619 discloses an example of a piston including a sealed cooling gallery partially filled with a liquid containing metal particles having a high thermal conductivity. The liquid carries the metal particles throughout the cooling gallery as the piston reciprocates in the internal combustion engine, and the metal particles remove heat from the crown. The metal particles can re-distribute the heat flow, and thus also reduces cooling gallery deposits, and oil degradation.

However, engine and piston manufacturers continuously strive to develop new and improved ways to reduce and control the temperatures of pistons.

### SUMMARY

One aspect of the invention provides a piston for an internal combustion engine capable of operating at reduced or more controlled temperatures. The piston comprises a piston body extending along a central longitudinal axis. The piston body has an upper combustion wall forming an upper combustion surface and an undercrown surface opposite the upper combustion surface. The piston body also includes a ring belt region depending from the upper combustion surface, a pair of skirt panels depending from the ring belt region, and a pair of pin bosses depending from the undercrown surface, wherein the pin bosses provide a pair of laterally spaced pin bores. The piston body includes one of an open outer cooling gallery forming a portion of the undercrown surface, a sealed outer cooling gallery forming a portion of the undercrown surface, and an outer galleryless region forming a portion of the undercrown surface. The piston body also includes a central undercrown region forming a portion of the undercrown surface. A coating is applied to at least one of the portions of the undercrown surface, but not applied to at least one area of at least one of the portions of the undercrown surface. The coating comprises a base layer including nickel and a catalyst layer including rhodium disposed on the base layer.

Another aspect of the invention provides a method of manufacturing the piston for an internal combustion engine. The method comprises the steps of providing the piston body, applying the coating to at least one of the portions of the undercrown surface and not applying the coating to at least one of the portions of the undercrown surface. The step of applying the coating includes applying a base layer including nickel to the undercrown surface, and applying a catalyst layer including rhodium on the base layer.

### BRIEF DESCRIPTION OF THE DRAWINGS

These and other aspects, features and advantages of the invention will become more readily appreciated when considered in connection with the following detailed description, appended claims and accompanying drawings, in which:

FIG. 1 is a dual cross-sectional side view of a piston constructed in accordance with one aspect of the invention shown taken generally transversely to a pin bore axis to the left of axis A, and shown taken generally along the pin bore axis to the right of axis A;

FIG. 1A is a view similar to FIG. 1 of a piston constructed in accordance with another aspect of the invention;

FIG. 1B is a dual cross-sectional side view of a piston constructed in accordance with another aspect of the invention shown taken generally transversely to a pin bore axis to the left of axis A, and shown taken generally along the pin bore axis to the right of axis A;

FIG. 2 is a view similar to FIG. 1 of a piston constructed in accordance with another aspect of the invention;

FIG. 3 is a view similar to FIG. 1 of a piston constructed in accordance with yet another aspect of the invention; and

FIG. 4 is an enlarged view of a coating disposed on an undercrown surface of a piston according to an example embodiment.

### DETAILED DESCRIPTION OF EXEMPLARY EMBODIMENTS

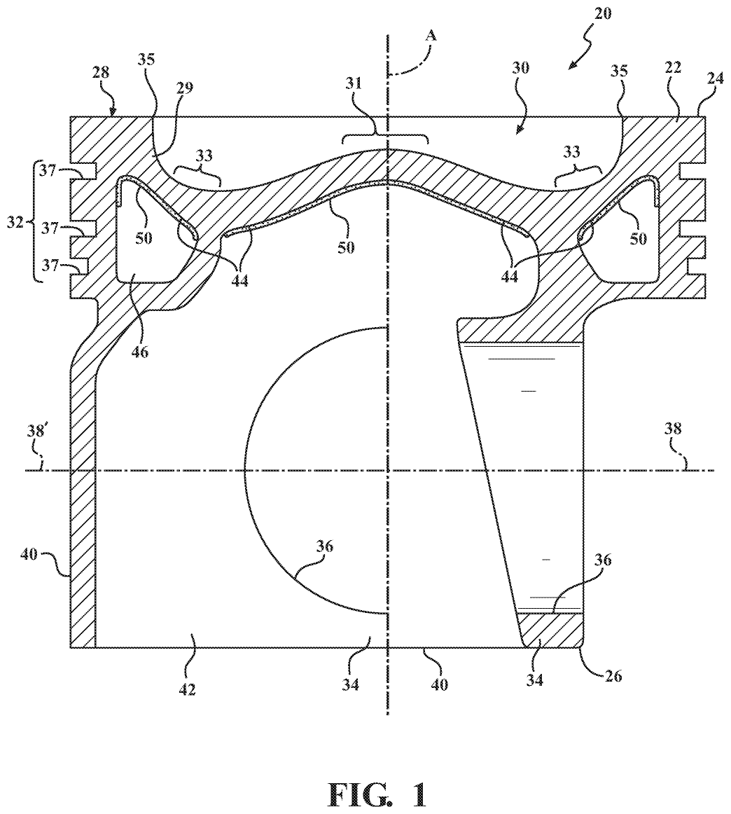

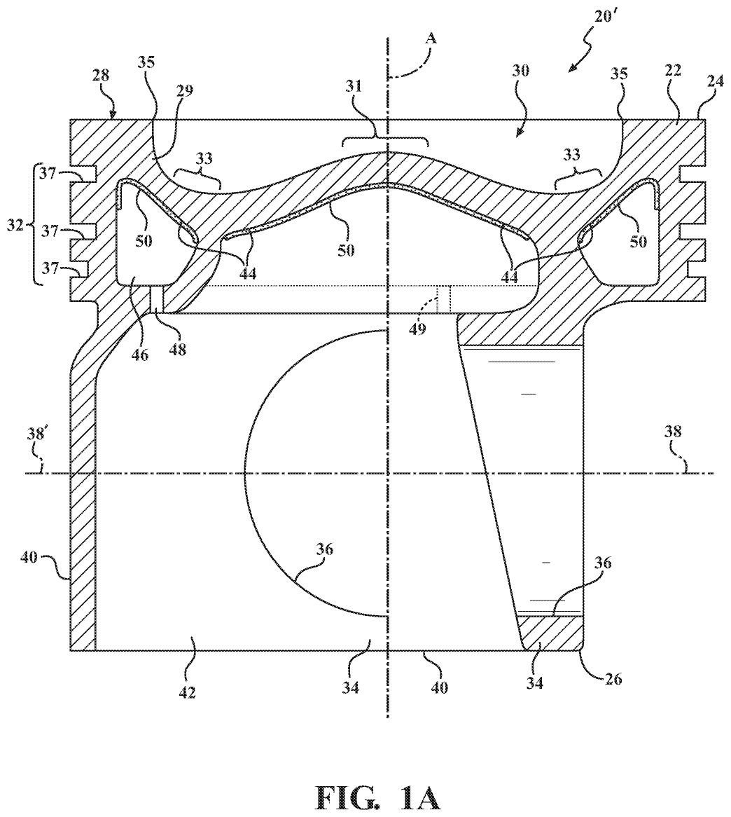

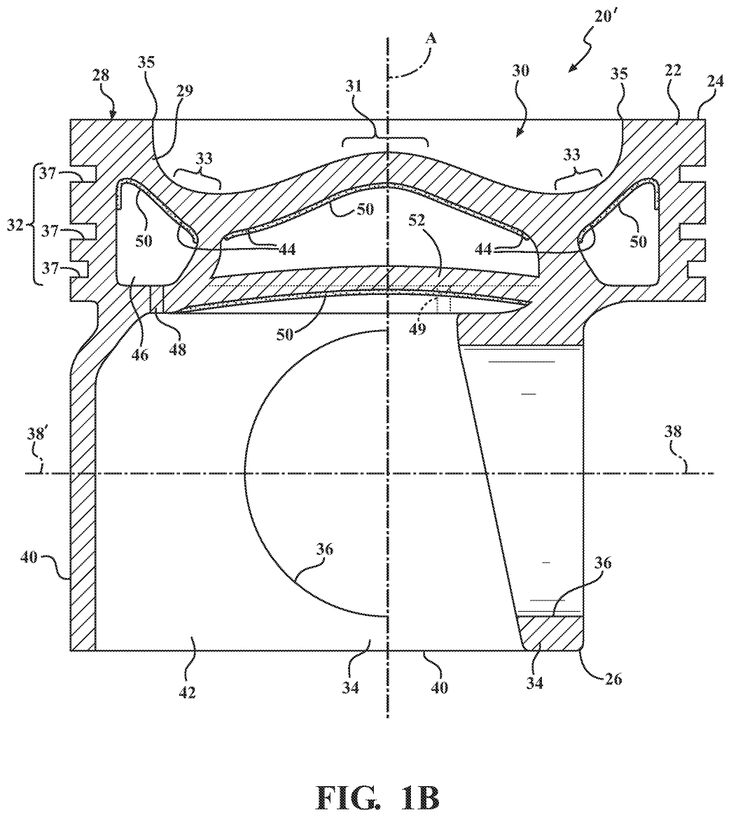

Referring in more detail the drawings, FIGS. 1-3 illustrate respective pistons 20, 20′, 20″, 20′″ for an internal combustion engine according to different example embodiments of the invention. The pistons 20, 20′, 20″, 20′″ are discussed hereafter using the same reference numerals to identify like features. The pistons 20, 20′, 20″, 20′″ each have a body 22 formed of a metal material, such as steel, cast iron, or a non-ferrous material, such as aluminum. The body 22 extends along a center axis A, along which the pistons 20, 20′, 20″, 20′″ reciprocate in use, from an upper end 24 to a lower end 26. The body 22 of the pistons 20, 20′, 20″, 20′″ include a crown 28 at the upper end 24 of an upper combustion wall 29, wherein the crown 28 is directly exposed to a combustion chamber and hot gases therein during use, with a combustion bowl 30 depending therein.

In the example embodiments, the combustion bowl 30 of the body 22 presents an apex region 31 about the center axis A, a concave, toroidal bowl-shaped valley region 33 surrounding the center axis A, and a bowl-rim 35 surrounding the valley 33. An annular ring belt 32 depends from the crown 28 to present a plurality of ring grooves 37 facing away from the center axis A and extending circumferentially around the center axis A.

The pistons 20, 20′, 20″, 20′″ further include a lower part presenting a pair of pin bosses 34, each depending from the crown 28, having pin bores 36 aligned with one another along a pin bore axis 38 extending perpendicular to the center axis A for receiving a wrist pin (not shown). The body 22 also includes a pair of diametrically opposite skirt panels 40 depending from the crown 28 and extending along a circumferential direction partially about the center axis A along opposite sides of the pin bore axis 38. The skirt panels 40 are joined to the pin bosses 34 via strut portions 42. It is noted that the body 22 of the pistons 20, 20′, 20″, 20′″ could comprise various other designs and features than those shown in FIGS. 1, 1A-3.

The lower part of the body 22 of the piston 20 also presents an undercrown surface 44 on an opposite side of the upper combustion wall 29 from the crown 28, and facing opposite the combustion bowl 30. The piston 20 can optionally include an outer cooling gallery 46 in addition to the undercrown surface 44, as shown in FIGS. 1 and 1A. In these embodiments, the outer cooling gallery 46 is disposed adjacent the ring belt 32 in radial alignment or substantial radial alignment therewith (substantial is intended to mean that at least a portion of the outer cooling gallery 46 is radially aligned with the ring belt 32, but a portion may not be radially aligned with the ring belt 32), wherein the cooling gallery 46 extends circumferentially around the center axis A. As shown in FIG. 1, the outer cooling gallery 46 can be sealed to contain a cooling media therein, which can be a solid, liquid, and/or gas. According to one embodiment, the sealed outer cooling gallery 46 can be filled with air. Otherwise, as shown in FIG. 1A, the outer cooling gallery 46 can be open, thereby including inlet and outlet openings 48, 49, such that cooling oil from a crankcase can enter and exit the outer cooling gallery 46, such as by being sprayed into the inlet opening 48 and allowed to exit the outlet opening 49. If desired, the inlet and outlet openings 48, 49 can be sealed, for example a plug, adhesive, weld, or braze, with the desired cooling medium disposed therein, to form the sealed cooling gallery of FIG. 1.

In the examples of FIGS. 1 and 1A, the piston 20, 20′ includes a central region of the undercrown surface 44 located along the center axis A and surrounded by the sealed or open outer cooling gallery 46. The central region of the undercrown surface 44 is open and shown located directly opposite the apex region 31 of the combustion bowl 30 so that cooling oil from the crankcase can be sprayed or splashed onto the central region of the undercrown surface 44. However, the central region of the undercrown surface 44 could alternatively be closed or sealed off from direct exposure to the crankshaft region. A further portion of the undercrown surface 44 is formed by the uppermost surfaces of the open or sealed outer cooling gallery 46 opposite the valley region 33. It is noted that the center region of the undercrown surface 44 does not need to be open as shown in FIGS. 1 and 1A. The body 22 could also include an inner wall 52 providing another section of the central region of the undercrown surface 44, as shown in FIG. 1B. In the example embodiment, this inner wall 52 includes a drilled opening.

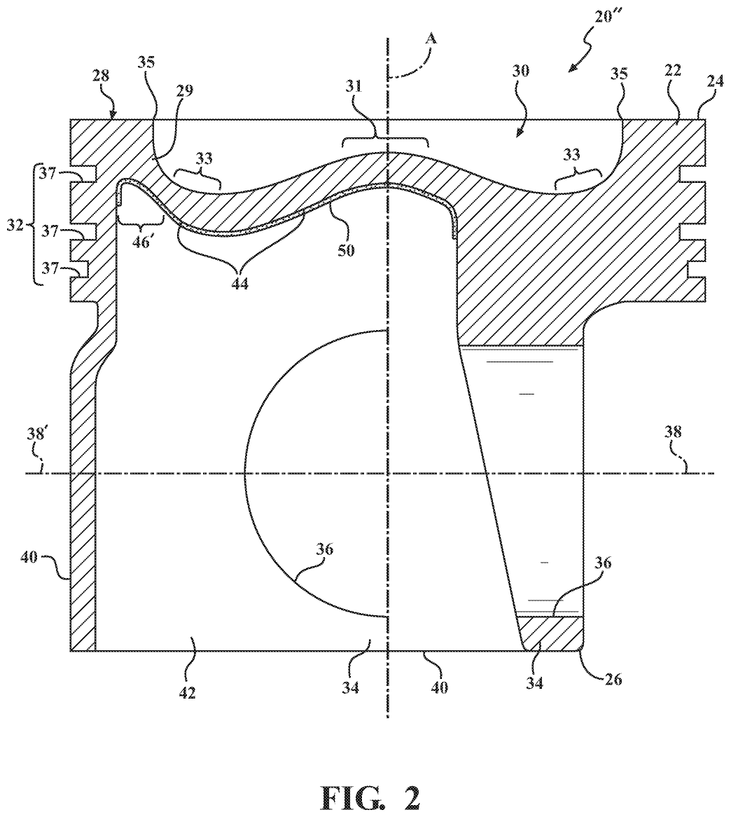

In the example embodiment of FIG. 2, the piston 20″ does not include a closed or sealed outer cooling gallery, but instead includes an open outer galleryless region 46′ and the central region of the undercrown surface 44, which are both openly exposed along the lower part of the piston 20″. The open galleryless region 46′ is shown as extending only along a pair of diametrically opposite regions of the piston 20″, wherein one of the regions extends along one side of the pin bore axis 38 generally parallel thereto and generally transversely to a thrust axis axis 38′, and the other of the other of the regions extends along another side of the pin bore axis 38 generally parallel thereto and generally transversely to the thrust axis 38′. Accordingly, the open galleryless region 46′ is formed to extend along opposite sides of the pin bore axis 38, radially inwardly from the skirt panels 40 and in radial alignment with or substantial radial alignment with the ring belt 32. In the embodiment of FIG. 2, a further outer portion of the undercrown surface 44 is formed by the uppermost surfaces of the outer galleryless region 46′, and portions of the pin bosses 34 located above the pin bores 36 and extending to the ring belt 32 are solid piston body material. The central region of the undercrown surface 44 and the outer portion of the undercrown surface 44 extends from the center axis A to the regions of the ring belt 32 located in axial alignment with the skirt panels 40.

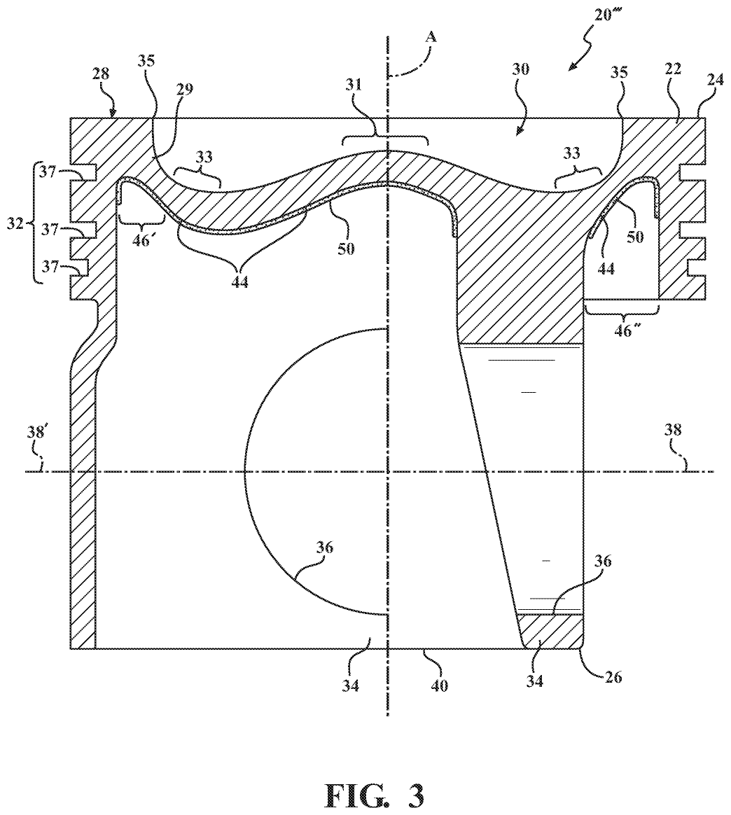

In the embodiment of FIG. 3, the piston 20′″ is similar to the piston 20″; however, rather than having an entirely solid piston body portion above and axially aligned with the pin bosses 34, extending to the ring belt 32, a pocket or second open outer galleryless region 46″ is located radially outwardly of the pin bosses 34 adjacent and in radial alignment with the ring belt 32. As such, the second open outer galleryless region 46″ allows the cooling of the entirety or substantial entirety of the ring belt region 32 to be enhanced via the combined circumferentially continuous configuration provided by the first and second galleryless regions 46′, 46″. In the embodiment of FIG. 3, the undercrown surface 44 is provided by the combination of the uppermost surfaces/portions of the open galleryless regions 46′, 46″ generally opposite the valley region 33 of the combustion bowl 30 and the central region of the undercrown surface 44 opposite the apex region 31 of the combustion bowl 30.

As shown in the Figures, a coating 50 is applied to at least a portion of the undercrown surface 44, and thus, to at least one of the undercrown portions provided by the open or sealed outer cooling gallery 46, and/or the outer galleryless regions 46′, 46″, and/or the open or sealed central region of the undercrown surface 44. The coating 50 acts to catalyze reactions with crankcase oil. The resulting coking layer that forms is thermally insulative and serves as a thermal barrier.

The coating 50 is preferably selectively applied to the undercrown surface 44 in patches so that metal of one or more portions of the undercrown surface 44 remains exposed or at least free of the coating 50. Thus, the coating 50 is applied to less than all of the portions of the undercrown surface 50. The coating 50 can be applied to at least one of the portions of the undercrown surface 44 but not applied to at least one area of at least one of the portions of the undercrown surface 44. For example, the coating 50 can be applied to a plurality of areas of at least one of the portions of the undercrown surface 44.

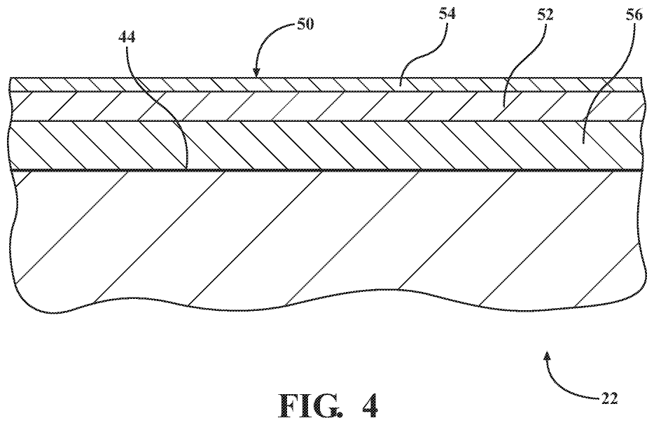

The coating 50 comprises a base layer 52 including nickel and a catalyst layer 54 including rhodium disposed on the base layer 52, as shown in FIG. 4. The coating 50 can also include a first layer 56 of copper between the undercrown surface 44 and the base layer 52. An example of the coating 50 on a portion of the undercrown surface 44 is shown in FIG. 4. The base layer 52 is formed of nickel or a nickel alloy, and the catalyst layer 54 is formed of rhodium or a rhodium alloy. According to an example embodiment, the base layer 52 includes at least 5 wt. % nickel, based on the total weight of the base layer 52; and the catalyst layer 54 includes at least 10 wt. % rhodium, based on the total weight of the catalyst layer 54. For example, the base layer 52 can include 5 to 100 wt. % nickel, and the catalyst layer 54 can include 10 to 100 wt. % rhodium. The remaining balance of the base layer is comprised of a single metal or combination of metals such as, but not limited to copper, silver, gold or platinum. The remaining balance of the catalyst layer is comprised of a single catalyst metal or combination of metals from the platinum groups metals, such as but not limited to platinum, palladium, osmium, iridium and ruthenium.

According to an example embodiment, the base layer 52 has a thickness ranging from 1 to 100 microns, the catalyst layer 54 has a thickness ranging from 1 nanometer to 10 microns, and the optional first layer 56 has a thickness of 1 to 100 microns.

The purpose of the catalyst layer 54 is to encourage and accelerate the degradation of oil in temperature critical regions of the piston body 22 so that an insulative coking layer can be formed in an accelerated manner. The result is a piston 20 that can adapt to differing duty cycle conditions in order to reduce long term oil degradation. The catalyst layer 54 can also stabilize piston temperatures earlier in the service life of the piston 20.

The coating 50 is preferably applied by electrodepositing the layers on the undercrown surface 44, but the coating 50 could be applied by other methods.

The coating 50 could be applied to the entire undercrown surface 44. However, the coating 50 is typically applied to less than the entire undercrown surface 44 of the piston body 22. For example, the coating 50 can be selectively applied to regions of the undercrown surface 44 that are able to most significantly control the temperature of the piston 20. For example, the coating 50 can be applied to only the central region of the undercrown surface 44, only the open or sealed outer cooling gallery 46, and/or only one of the outer galleryless regions 46′, 46″ forming a portion of the undercrown surface 44. Alternatively, the coating 50 can be applied to two or more, but less than all of, those regions, or to all of those regions.

The coating 50 can be applied as a patch, as shown in FIG. 2. For example, the coating 50 can be applied to a first area of one of the portions of the undercrown surface 44 but not a second area of the same one of the portions of the undercrown surface 44. In example embodiments, the coating 50 can be applied as a patch to less than all of one or more of the following portions: the open or sealed outer cooling gallery 46, the outer galleryless regions 46′, 46″, and the central region of the undercrown surface 44.

In the embodiments of FIGS. 2 and 3, the piston body 22 includes the outer galleryless region 46′, 46″ forming a portion of the undercrown surface 44, and the coating 50 is applied to the portion of the undercrown surface 44 formed by the outer galleryless region 46′, 46″. In this case, the coating 50 can be applied to less than all of the portion of the undercrown surface 44 formed by the outer galleryless region 46′, 46″.

According to another example embodiment, as shown in FIG. 1A, the piston body 22 includes the outer cooling gallery 64 forming a portion of the undercrown surface 44, the oil inlet opening 48 configured for oil to be sprayed in the cooling gallery 46, and the outlet opening 49 configured for the oil to exit the outer cooling gallery 46. In this case, the coating 50 is applied to the portion of the undercrown surface 44 formed by the outer cooling gallery 64.

According to yet another example embodiment, as shown in FIG. 1, the piston body 22 includes the sealed outer cooling gallery 64 forming a portion of the undercrown surface 44. In this case, the coating 50 is applied to the portion of the undercrown surface 44 formed by the closed outer cooling gallery 64.

In the embodiments of FIGS. 1, 1A, 1B, 2, and 3, the coating 50 is also applied to the central region of the undercrown surface 44.

The piston 20 including the coating 50 can provide numerous benefits when used in an internal combustion engine. Pistons typically accumulate undercrown coking at a rate determined by the high surface temperatures of the piston, which are typically greater than 350° C., and the contact time of the oil as it splashes and flows. These same factors also affect the maximum thickness of the resulting undercrown coking layer. As power density continues to increase, so will the piston temperatures. Increased piston temperatures are driving an increased need to manage the heat transfer properties of pistons.

The coating 50 described herein can be selectively applied to the undercrown surface 44 to increase the rate at which undercrown coking, an insulator, accumulates on the undercrown surface 44 or bottom side of the piston 20. This additional control will allow coking, which is traditionally viewed as a nuisance, to be used as a tool to reduce heat transfer through specific surfaces of the piston body 22 and increase the rate of heat transfer through other structures of the piston body 22, such as ring-pack or pin boss, to better control the temperature of the piston 20.

One preferred application for the coating 50 is to encourage undercrown coking in applications with high undercrown surface temperatures, for example the galleryless piston design. This coking layer would enable increased oil life after a predictable break-in. Alternately, selective application of the coating 50 can provide for a piston 20 that adapts its heat transfer properties to its duty cycle. For example, increasing the coking rate of the piston 20 throughout the break in of a high or low duty cycle engine means that the engine will more quickly accumulate it's maximum coking layer thickness. This can ensure more consistent piston temperatures, and thus emissions earlier in the engine's life. In summary, the coating 50 described herein turns a problem i.e. coking deposits, into a beneficial thermal barrier layer.

The coating 50 is also cost effective, as it can be easily applied to the piston body 22. The coating 50 typically includes only a few microns of the electrodeposited nickel base layer 52 and the electrodeposited rhodium catalyst layer 54 over the top of the nickel base layer 52. If needed, a few microns of the copper first layer 56 can be plated underneath the nickel base layer 52 to even out temperature hotspots, since copper has very high thermal conductivity of 400 w/M·K. The catalyst layer 54 can include as little as a few nanometers of rhodium which is enough to exhibit catalytic activity, but typically a few microns of the rhodium catalyst layer 54 will be plated over the nickel base layer 52.

The rhodium catalyst layer 54 can accelerate the breakdown of engine oil only in the regions where the thermal barrier is needed, such as undercrown pockets 46″ or within a cooling gallery 46, 46′. The hydrocarbons in the oil degrade and evaporate leaving the remains of the oil additive package to form an insulating inorganic deposit. From about 350° C. up, the remaining mass % of oil decreases to 1% depending on the temperature. In addition, thermogravimetric Analysis (TGA) has shown that the deposits left by completely degraded oil represent 1% of the initial mass of the oil. The rhodium catalyst layer 54 allows for a more rapid accumulation of deposits for a given surface temperature. Thus, the deposition more rapidly approaches a point of equilibrium than the surroundings hence limiting the deposit rate as the added material acts as a thermal barrier and lowers the undercrown temperature at the interface with liquid oil, since the coated metals are robust at high temperatures, such as temperatures greater than 600° C. Also, the undercrown surfaces 44 and other cooling gallery surfaces of forged piston bodies 22 including a top and bottom can be coated before welding without the risk of damage from the temperatures reached during friction welding or hybrid induction welding.

In summary, the coating 50 can accelerate deposits in the initial formation phase then self-limits when thickness increases to a point where equilibrium between the coking formation rate and surface temperature of the piston is reached. The coating 50 is adaptive and can change in response to the engine service conditions. In effect, the coating 50 can form an “adaptive thermal barrier” and allow the piston 20 to adapt to its service environment. The coating 55 could also be viewed as a self-healing coating that responds to extreme hotspots and cures itself. The chemical properties of the coating 50 encourage coking formation, which is a unique approach.

Another aspect of the invention provides a method of manufacturing the piston 20, 20′, 20″, 20′″ including the coating 50. The body 22 of the piston 20, 20′, 20″, 20′″, which is typically formed of steel, cast iron, or a non-ferrous material containing aluminum, can be manufactured according to various different methods, such as forging or casting. For example, the body 22 can include two pieces, a top and bottom, which are forged and then welded together. The body 22 of the piston 20, 20′, 20″, 20′″ can also comprise various different designs, and examples of the designs are shown in FIGS. 1, 1A-3.

The method further includes applying the coating 50 to at least a portion of the undercrown surface 44, including at least a portion of the central region of the undercrown surface 44, and/or at least a portion of the outer cooling gallery 46, and/or at least a portion of the first and/or second open outer galleryless region 46′, 46″. The method also includes not applying the coating 50 to at least one of the portions of the undercrown surface 44, so that one or more areas of the undercrown surface 44 remains exposed or free of the coating 50.

The step of applying the coating 50 includes applying the base layer 52 including nickel to the undercrown surface 44, and then applying a catalyst layer 54 including rhodium to the base layer 52. The method can also include applying a first layer 56 of copper on the undercrown surface 44 before applying the base layer 52.

Various different methods can be used to apply the coating 50. According to one example embodiment, the method includes electrodepositing the layers 52, 54, 56 of the coating 50 on the undercrown surface 44. To achieve the one or more patches or select portions of the coating 50 on the undercrown surface 44, the method can include masking at least one area of at least one of the portions of the undercrown surface 44 while applying the coating 50. The step of applying the coating 50 can include applying the coating 50 to less than all of the portions of the undercrown surface 44. The step of applying the coating 50 can include applying the coating 50 to a first area of one of the portions but not a second area of one of the portions of the undercrown surface 44. For example, the coating 50 can be selectively applied to regions of the undercrown surface 44 that most need to be isolated from the oil, surface 44. For example, the coating 50 can be applied to only the central region of the undercrown surface 44, only the outer cooling gallery 46, or only one of the outer galleryless regions 46′, 46″ forming a portion of the undercrown surface 44. Alternatively, the coating 50 can be applied to two or more, but less than all of, those regions. The coating 50 can also be applied to only a small area of one of the portions of the undercrown surface 44.

Alternatively, the method can include applying the coating 50 to the entire undercrown surface 44. The method can also include applying the coating 50 to other surfaces of the galleries 46, 46′, 46″.

Many modifications and variations of the present invention are possible in light of the above teachings and may be practiced otherwise than as specifically described while remaining within the scope of the claims. It is contemplated that all features of all claims and of all embodiments can be combined with each other, so long as such combinations would not contradict one another.

What is claimed is:

1. A piston for an internal combustion engine, comprising:
a piston body extending along a central longitudinal axis;
said piston body having an upper combustion wall forming an upper combustion surface and an undercrown surface opposite said upper combustion surface;
said piston body including a ring belt region depending from said upper combustion surface, a pair of skirt panels depending from said ring belt region, and a pair of pin bosses depending from said undercrown surface, said pin bosses providing a pair of laterally spaced pin bores;
said piston body including one of an open outer cooling gallery forming a portion of said undercrown surface, a sealed outer cooling gallery forming a portion of said undercrown surface, and an outer galleryless region forming a portion of said undercrown surface;
said piston body including a central undercrown region forming a portion of said undercrown surface;
a coating applied to at least one of said portions of said undercrown surface and not applied to at least one area of at least one of said portions of said undercrown surface; and
said coating comprising a base layer including nickel and a catalyst layer including rhodium disposed on said base layer.

2. The piston of claim 1, wherein said base layer has a thickness ranging from 1 to 100 microns, and said catalyst layer has a thickness ranging from 1 nanometers to 10 microns.

3. The piston of claim 1, wherein said base layer is formed of nickel or a nickel alloy and said catalyst layer is formed of rhodium or a rhodium alloy.

4. The piston of claim 3, wherein said base layer includes at least 5 wt. % nickel, based on the total weight of said base layer; and said catalyst layer includes at least 10 wt. % rhodium, based on the total weight of said catalyst layer.

5. The piston of claim 1, wherein said coating is applied to a plurality of areas of at least one of said portions of said undercrown surface.

6. The piston of claim 1, wherein said coating includes a first layer of copper disposed between said undercrown surface and said base layer.

7. The piston of claim 1, wherein said piston body is formed of steel, cast iron, or a non-ferrous material containing aluminum.

8. The piston of claim 1, wherein said coating is applied to less than all of said portions of said undercrown surface.

9. The piston of claim 1, wherein said piston body includes an outer galleryless region forming a portion of said undercrown surface, and said coating is applied to said portion of said undercrown surface formed by said outer galleryless region.

10. The piston of claim 9, wherein said coating is applied to less than all of said portion of said undercrown surface formed by said outer galleryless region.

11. The piston of claim 1, wherein said piston body has said open outer cooling gallery forming a portion of said undercrown surface, an inlet configured for oil to be sprayed in said open cooling gallery, and an outlet configured for the oil to exit said open cooling gallery; and said coating is applied to said portion of said undercrown surface formed by said open outer cooling gallery.

12. The piston of claim 1, wherein said piston body includes a sealed outer cooling gallery forming a portion of said undercrown surface, and said coating is applied to said portion of said undercrown surface formed by said sealed outer cooling gallery.

13. The piston of claim 1, wherein said piston body includes a central undercrown region forming a portion of said undercrown surface, and said coating is applied to said portion of said undercrown surface formed by said central undercrown region.

14. A method of manufacturing a piston for an internal combustion engine, comprising the steps of:
providing a piston body extending along a central longitudinal axis;
the piston body having an upper combustion wall forming an upper combustion surface and an undercrown surface opposite the upper combustion surface, a ring belt region depending from the upper combustion surface, a pair of skirt panels depending from the ring belt region, and a pair of pin bosses depending from the undercrown surface, the pin bosses providing a pair of laterally spaced pin bores;
the piston body including one of an open outer cooling gallery forming a portion of the undercrown surface, a sealed outer cooling gallery forming a portion of the undercrown surface, or an outer galleryless region forming a portion of said undercrown surface, and the piston body include a central undercrown region forming a portion of said undercrown surface;
applying a coating to at least one of the portions of the undercrown surface and not applying the coating to at least one of the portions of the undercrown surface; and
the step of applying the coating including applying a base layer including nickel to the undercrown surface, and applying a catalyst layer including rhodium on the base layer.

15. The method according to claim 14 including masking at least one area of at least one of the portions of the undercrown surface while applying the coating.

16. The method according to claim 14, wherein the step of applying the coating includes applying the coating to less than all of the portions of the undercrown surface.

17. The method according to claim 14, wherein the step of applying the coating includes applying the coating to a first area of one of the portions but not a second area of one of the portions of the undercrown surface.

18. The method of claim 14, wherein the step of applying the coating includes electrodepositing the layers.

19. The method of claim 14, wherein the step of applying the coating includes applying a first layer of copper on the undercrown surface before applying the base layer.

20. The method of claim 14, wherein the base layer has a thickness ranging from 1 to 100 microns, and the catalyst layer has a thickness ranging from 1 nanometers to 10 microns.
